(19) United States
(12) Patent Application Publication
(10) Pub. No.: US 2016/0316331 A1
(43) Pub. Date: Oct. 27, 2016

(54) PROXIMITY-BASED MESSAGING

(71) Applicant: Matthew Hargraves, Grand Blanc, MI (US)

(72) Inventor: Matthew Hargraves, Grand Blanc, MI (US)

(21) Appl. No.: 15/139,303

(22) Filed: Apr. 26, 2016

Related U.S. Application Data
(60) Provisional application No. 62/153,453, filed on Apr. 27, 2015.

(51) Int. Cl. H04W 4/02; H04W 8/06; H04W 4/12; H04W 4/06

(52) U.S. Cl. CPC H04W 4/022; H04W 4/06; H04W 8/06; H04W 4/12; H04W 88/184

(57) ABSTRACT

A messaging system and a method of providing messages between communication devices using a computer server is described. The method includes: receiving at the computer server registration data from a plurality of communication devices, wherein each registration data includes predefined geographic data that includes the respective communication device; receiving at the computer server location data from a source device, wherein the source device is the one of the plurality of communication devices; receiving a message from the source device; determining a target device from among the plurality of communication devices, wherein the target device is determined when the location data of the source device is within a region associated with the predefined geographic data of the target device; and in response to the determination, transmitting the message to the target device.

This application claims the benefit of U.S. Provisional Patent Application 62/153,453, filed Apr. 27, 2015.

### TECHNICAL FIELD

The present disclosure relates to proximity sensitive message, and more particularly to transmitting message data between communication devices based on proximity using a computer server.

### BACKGROUND

Electronic messaging enables virtually instantaneous communication. For example, mobile phones have the ability to transmit short messages via Short Message Service (or SMS). Desk-top computers may use so-called instant messengers to communicate with other desk-top computers or mobile devices. These and other electronic messages come in a variety of formats, including text, still images, video, etc. These types of messaging can send messages throughout a region, even throughout the world. However, there is a need to provide proximity-based messaging so that a number of other electronic device users may receive the sender's message based on their locality. More so, it is desirable that the electronic device recipients of the message be able to define the locality.

### SUMMARY

According to an embodiment of the present disclosure, there is provided a method of providing messages between communication devices using a computer server. The method includes: receiving at the computer server registration data from a plurality of communication devices, wherein each registration data includes predefined geographic data that includes the respective communication device; receiving at the computer server location data from a source device, wherein the source device is the one of the plurality of communication devices; receiving a message from the source device; determining a target device from among the plurality of communication devices, wherein the target device is determined when the location data of the source device is within a region associated with the predefined geographic data of the target device; and in response to the determination, transmitting the message to the target device.

According to another embodiment of the present disclosure, there is provided a non-transitory computer readable medium having data stored therein representing application software executable by a mobile device, the software having instructions, the instructions including: storing registration data received from a user of the mobile device; determining location data of the mobile device; providing the registration data and the location data to a computer server in communication with a plurality of communication devices; receiving user input representing a first message intended for delivery to a target device, wherein the target device is one of the plurality of communication devices; and transmitting the first message to the computer server for intended delivery to the target device, wherein the first message is received by the target device when the location data of the mobile device is within a geographic region predefined by a user of the target device.

### BRIEF DESCRIPTION OF THE DRAWINGS

One or more embodiments of the invention will hereinafter be described in conjunction with the appended drawings, wherein like designations denote like elements, and wherein:

FIG. 1 is a block diagram depicting an embodiment of a messaging system that is capable of utilizing the method disclosed herein;

FIG. 2 is a flow diagram depicting a method of providing messages using messaging system devices shown in FIG. 1;

FIG. 3 is an embodiment of a plurality of categorical identifiers associated with one of the communication devices shown in FIG. 1;

FIG. 4 a flow diagram depicting one embodiment of a registration process associated with the messaging system of FIG. 1;

FIG. 5 is a flow diagram depicting one embodiment of a process for determining target device(s) of the messaging system of FIG. 1; and

FIG. 6 is a schematic diagram illustrating spatial relationships between three illustrative communication devices.

### DETAILED DESCRIPTION OF THE ILLUSTRATED EMBODIMENT(S)

A messaging system is described below that enables a user of one communication device to send a message to recipient users of different communication devices. The term message as used herein includes any suitable data or communication. The recipient communication device may be preconfigured so that the message is received from the sender only if the sender is within a predetermined geographic region of the recipient. In addition, whether messages are received via the messaging system can depend upon a setting saved by the recipient. Further, messages may be associated with different categorical identifiers (e.g., group and subgroups) which also may be configured by both the sender and the recipient. In this manner, not only is the recipient capable of regulating the receipt of messages based upon the geographic proximity of the sender, but also according to a common group or subgroup(s) to which both the sender and recipient belong. As will be described in greater detail below, the messaging system comprises one or more computer servers configured to control the transmission of messages sent and received by the respective sender and recipient communication devices.

### Communication System—

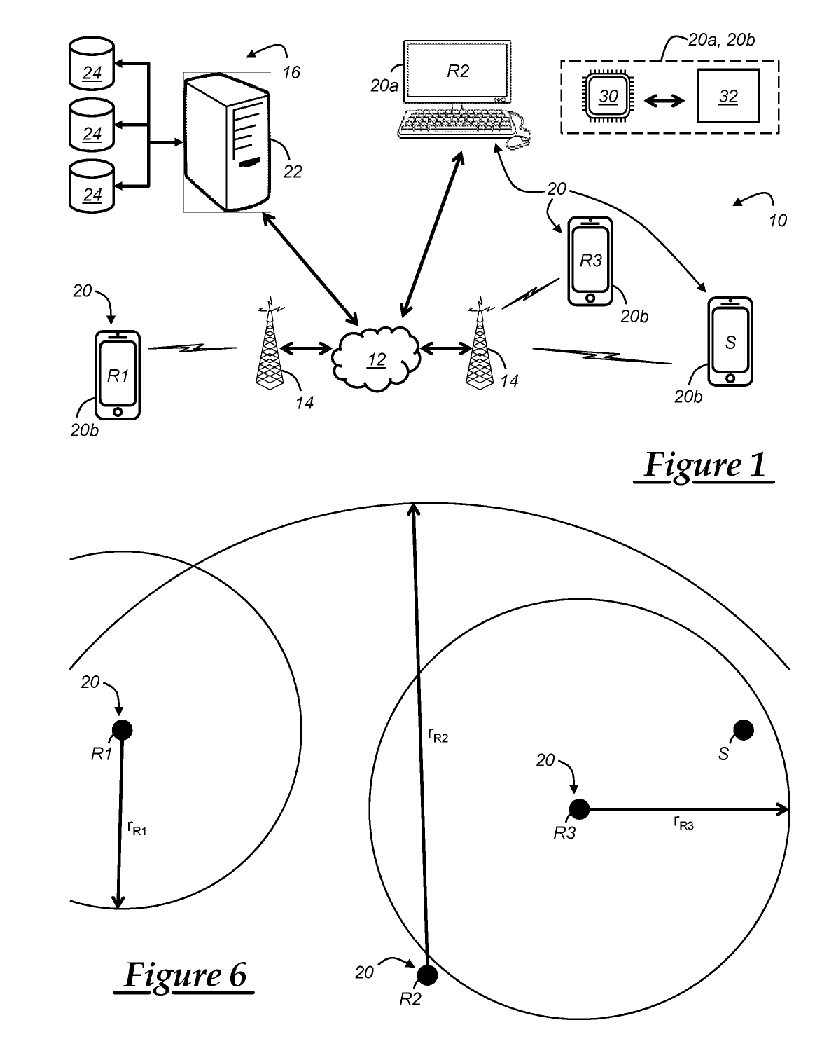

FIG. 1 illustrates a messaging communication system 10 that includes a land network system 12, wireless communication infrastructure 14, a computer server 16, and several communication devices 20 in communication with one another via the computer server 16 (using land network system 12 and/or wireless communication infrastructure 14). Land network system 12 may be a land-based telecommunications network that comprises one or more interconnected landline telephones and is connected to wireless communication infrastructure 14. Land network system 12 may include a public switched telephone network (PSTN) such as that used to provide hardwired telephony, packet-switched data communications, and the internet infrastructure. One or more segments of land network system 12 could be implemented through the use of a standard wired network, a fiber or other optical network, a cable network, power lines, other wireless networks such as wireless local area networks (WLANs), or networks providing broadband wireless access (BWA), or any combination thereof. Other aspects of land network systems 12, as well as their implementation and use, will be appreciated by skilled artisans and will therefore not be explained further here.

Wireless communication infrastructure 14 may be a cellular telephone system that includes a plurality of cell towers operable according to any suitable cellular communication technology (e.g., AMPS, CDMA, GSM/GPRS, LTE, etc.). Thus for example in GSM systems, infrastructure includes base station controllers (BSCs), mobile switching centers (MSCs), serving GPRS support nodes (SGSNs), home location registers (HLR), etc. Or in LTE systems, infrastructure includes enodeB, mobility management entities (MMEs), home subscriber servers (HSSs), serving gateways (SGWs), packet gateways (PGWs), etc. These are only meant as examples of wireless communication infrastructure 14; other examples also exist. Further, the illustrated wireless communication infrastructure 14 may include use of multiple communication technologies as well. As shown in FIG. 1, infrastructure 14 may be connected to land network system 12 and allow communications between computer server 16 and the communication devices 20.

Computer server 16 can be one of a number of remotely located computers accessible via a private or public network such as the internet. Computer server 16 may include one or more processors or processing centers 22 and be coupled to one or more databases 24 (several databases are shown; however, this is not required). Databases 24 may include storage devices that comprise any suitable non-transitory computer usable or readable medium; e.g., including but not limited to RAM (random access memory), ROM (read only memory), EPROM (erasable, programmable ROM), EEPROM (electrically erasable, programmable ROM), and/or magnetic or optical disks or tapes. Processing centers 22 can be any type of device capable of processing electronic instructions which may be stored at the processing center 22 or the database(s) 24. Non-limiting examples of processing centers 22 include microprocessors, microcontrollers, host processors, controllers, and application specific integrated circuits (ASICs), just to name a few examples; thus, in at least one embodiment, processing centers 22 may comprise data storage or internal memory storage devices as well. Each processing center 22 may be configured for dedicated operations associated with a predetermined categorical identifier used by the communications devices 20, as will be described in greater detail below. For example, computer server 16 may include any special-purpose computer system dedicated to facilitating at least a portion of the method(s) described herein. Regardless of the nature, type, or characteristics of the processing center(s), the centers 22 may execute various types of digitally-stored instructions, such as software or firmware programs stored within the processing centers 22 and/or in the databases 24, thereby enabling the processing center to perform a wide variety of tasks, as well as execute programs and/or process data to carry out at least a part of the method discussed herein.

Computer server 16 may be accessible via the land network system 12 (or even, in some implementations, via wireless communication (e.g., via infrastructure 14)). In at least some implementations, messages or message traffic passes between different communication devices 20 via the computer server 16. For example, when a communication device 20 provides a message to other communication devices 20, the message as well as other data may be received and processed by the computer server 16 before the other communication devices receive the message. And as will be explained in greater detail below, the computer server(s) 16 may determine which of the other communication devices 20 receive the message, in accordance with the desire of the respective recipients.

Communication devices 20 may include any suitable device for transmitting and/or sending electronic data; communication devices 20 include static and mobile devices capable of wired communication, wireless communication, or any combination thereof. The term static communication device (or simply static device) 20a should be construed broadly. One example of a static device 20a is a personal computer (PC) capable of accessing and enabling user-interaction with the internet (with or without executable software) or via a website portal. Such static devices may be any analog, digital, neural, etc. computing device that includes hardware, software, and/or firmware suitable for carrying out at least a portion of the methods described herein. Hardware includes one or more input and output interfaces—e.g., including a display, a keyboard, etc. Communication device hardware further includes one or more processors 30 (e.g., microprocessor(s)), memory 32, and any other suitable electronics. Other non-limiting examples of static devices 20a also include mainframe computers, minicomputers, microcomputers, and even supercomputers, just to name a few examples.

Mobile communication device (or simply mobile device) 20b includes any portable device which may be used for wired or wireless communication and should be broadly construed as well. Mobile device hardware may include one or more input and output interfaces—e.g., including a display, a keyboard, touch screen, pushbutton(s), one or more processors 30, and memory 32 (e.g., a non-transitory computer readable medium).

The processor(s) 30 and memory 32 (or memory devices) shown in FIG. 1 and described above with respect to the static and mobile devices may have characteristics and functions similar to the processing center 22 and database memory 24. Of course, in each of these cases, processor(s) 30 and memory 32 are adapted for operation and use with their respective communication device 20 instead of the computer server 16. For example, the processor 30 and memory 32 of the static device 20a may enable connectivity to the internet and/or web portal; or the processor 30 may execute instructions (e.g., software) stored on memory 32 that enables interaction with the computer server 16. Any suitably configured processor 30 and memory 32 may be part of static device 20a, mobile device 22b, or both.

Mobile device 20b may include any suitable firmware or software stored on memory 32 and executable by the one or more processors 32. In at least on embodiment, mobile device 20b includes application software for sending and receiving messages, according to at least a portion of the method described herein. The application software may include instructions enabling a user of the mobile device 20b to register the device with the computer server 16 and thereafter send messages to users of other static and mobile devices via the server, as well as selectively control receipt of messages from other users. The application software may utilize any suitable data transmission technique; e.g., by transmitting packet data that includes textual data and/or multimedia data, electronic mail (e-mail), short messaging service (e.g., SMS or texts), just to name a few non-limiting examples. In at least one implementation, application software may be downloadable via a third party provider and thereafter installed in memory 32 and executable by processor(s) 30 therein. For example, using a wired or wireless internet connection, static and/or mobile devices 20a, 20b could download application software, store the application software on their respective memory 32, and thereafter execute or run the application software using their respective processor(s) 30.

In some wireless implementations, mobile device 20b may be used to make cellular telephone calls across a wide geographic area using wireless communication infrastructure. In other implementations, mobile devices may communicate according to a number of short range wireless communication protocols (SRWC); SRWC is intended to be construed broadly and may include one or more suitable wireless protocols such as but not limited to: any Wi-Fi standard (e.g., IEEE 802.11); Wi-Fi Direct, Bluetooth, Digital Living Network Alliance (DLNA), or other suitable peer-to-peer standard; wireless infrared transmission; WiMAX; ZigBee™; and/or various combinations thereof. And of course, some mobile devices 20b may communicate using both cellular and SRWC communication, as will be appreciated by skilled artisans. In addition, some mobile devices 20b may be couplable to wired connections as well; e.g., an Ethernet, USB, or like connection providing internet connectivity or providing access to a website portal. Non-limiting examples of the mobile device 20b include a cellular telephone, a personal digital assistant (PDA), a Smart phone, a personal laptop computer or tablet computer having two-way communication capabilities, a netbook computer, a notebook computer, or any suitable combinations thereof.

### Method—

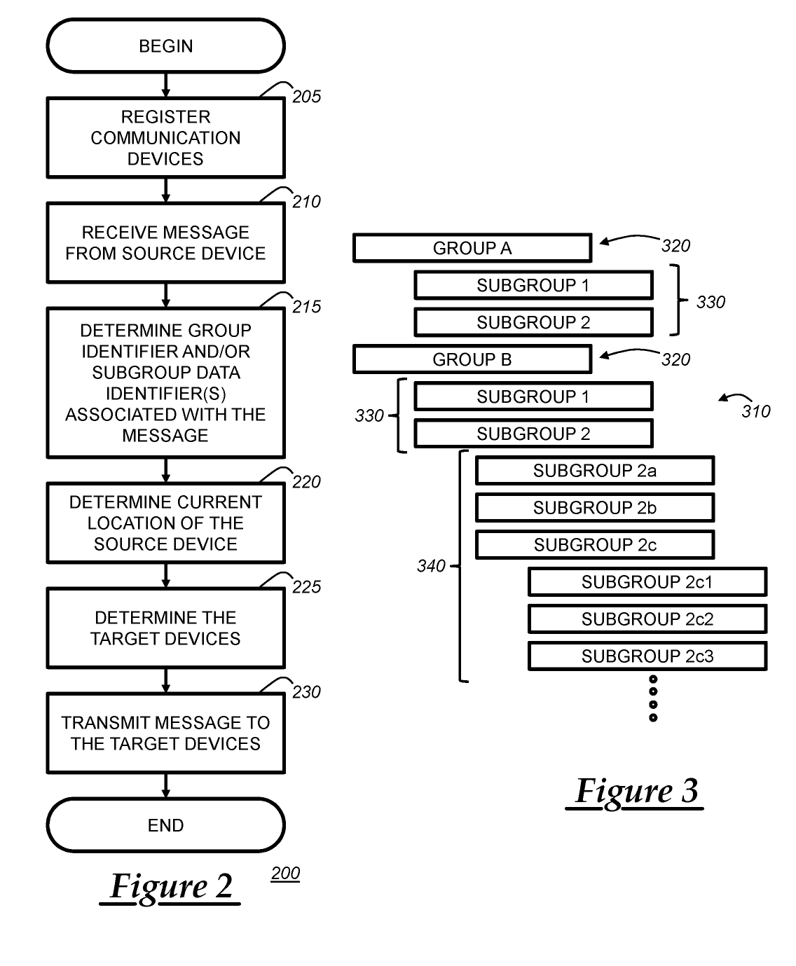

Turning now to FIG. 2, there is shown a method 200 of using the messaging system 10 described above. The method begins with step 205 which includes registering one or more communication devices 20 with computer server 16. Providing registration data to server 16 includes providing the computer server with categorical data and geographic data from at least some of the communication device(s) 20. FIG. 3 illustrates an example of categorical data which can include one or more categorical identifiers 310. In the illustration, the categorical identifiers 310 are shown as group identifiers 320 and subgroup identifiers 330. In some embodiments, one or more of the subgroup identifiers 330 may be further divided into other subgroup identifiers 340 as well (e.g., subgroups of the subgroups).

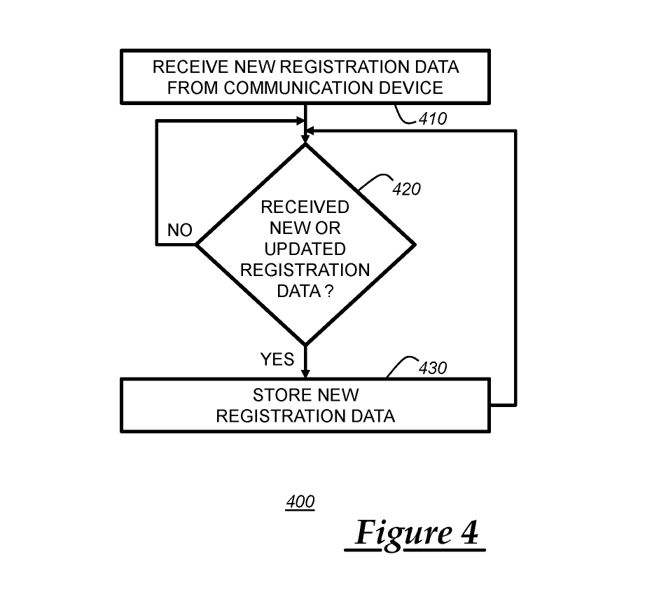

FIG. 4 illustrates a method 400 to execute step 205 of method 200. For example, step 410 (of method 400) includes receiving new registration data from one of the communication devices 20. The registration data may be stored at computer server 16 (e.g., in one or more of databases 24). WHAT IS REGISTRATION DATA?

Then, in step 420, computer server 16 may determine whether new or updated registration data is being received (e.g., provided to the server 16 from the respective communication device 20). When no new or updated registration data has been provided, then server 16 simply retains the last stored registration data (illustrated, e.g., by the method looping back and repeating step 420). Step 420 may be prompted by one or more triggers provided by the communication device 20 to server 16 (or from server 16 to communication device 20); e.g., the device 20 may be used to transmit or send new or updated registration data to the server 16 after the user of device 20 enters new or different information. In any case, when in step 420 it is determined that new or updated registration data has been received from the communication device 20, then method 400 proceeds to step 430.

In step 430, method 400 stores the new or updated registration data. With respect to at least a portion of the previous registration data, step 430 may include prepending (adding before) the new or updated registration data, appending (adding after) the new or updated registration data, otherwise supplementing the previous registration data with new or updated registration data, deleting or overwriting previous registration data, and/or saving or storing any new or updated registration data at server 16. Following step 430, method 400 may retain the new or updated registration data at server 16 until another update is received (again, illustrated by the method looping back and repeating step 420).

The method 400 shown in FIG. 4 is intended to illustrate that each communication device 20 may not only register with the computer server 16 but may also change its registration data at any time following its initial registration. It should be appreciated that updated registration data may include changing categorical identifiers (e.g., joining groups or subgroups, leaving groups or subgroups, changing geographic data associated with each group or subgroup—each group or subgroup being associated with a different group identifier 320 or subgroup identifier 330, 340). For example, a user may register his/her communication device 20 using categorical data associated with politics (or political subject matter). An example of categorical data could include a political party group (associated with a first group identifier 320) and various subgroup identifiers 330, 340 such as various political candidates, various federal and/or state issues, etc. Thus, the user might select or join a Libertarian Party group (e.g., associated with a first group identifier 320), a specific Libertarian candidate, such as the governor of Massachusetts subgroup (e.g., associated with a first subgroup identifier 330 of the group identifier 320), and how the candidate stands (e.g., his/her political platform) on a particular election issue, such as taxation (e.g., associated with a second subgroup identifier 340 of the subgroup identifier 330). As will be explained below, message traffic associated with that first group identifier 320, that first subgroup identifier 330, and/or that second subgroup identifier 340 will be provided to that user's communication device, depending upon the geographic data associated with each of the first group identifier 320, the first subgroup identifier 330, and/or the second subgroup identifier 340.

It should be appreciated that politics is merely an example of categorical data;

consequently, the political party, candidate, etc. discussed above are also merely examples. The groups and subgroups may be suggested to the user (e.g., predefined at the server 16), and in other implementations, the user may create or define the groups and subgroups. Where the user defines the groups and/or subgroups, the server may create or generate the suitable categorical identifiers 310 (associated therewith).

As referenced above, geographic data is received during step 410 as well; and the geographic data may be new or updated in steps 420 and 430 as well. The geographic data includes at least one geographic parameter which is associated with each communication device 20 and stored at computer server 16. Multiple geographic parameters may be associated with each communication device—e.g., one or more geographic parameters may be stored for each group identifier 320 and/or for each subgroup identifier 330, 340. In some instances, the geographic data (or parameters) may be predefined at server 16 and selectable by the user of the communication device 20; and in other instances, the geographic data (or parameters) may be defined by the user. In at least one implementation, the geographic data may include default parameter(s) for instances in which the user does not select or define the geographic data.

The geographic parameter may define a geographic region around the communication device 20. In one implementation, this geographic region may be a circle as shown in FIG. 6; thus, for example, the geographic parameter may be a radius extending outwardly from the communication device 20. FIG. 6 illustrates four communication devices 20 which have registered with server 16 (e.g. providing geographic data and/or categorical data)—e.g., each of the devices 20 correspond to the devices 20 shown in FIG. 1. For example, one device 20 is designated as a source device (S) [i.e., the source or sender of the message] and the remaining three devices 20 are designated as target or recipient devices (R1, R2, R3) [i.e., potential targets or recipients of the message as they belong to the same group and/or subgroup]. In this example, the geographic parameters of each recipient communication device 20 (R1, R2, R3) are shown as radii r_{R1}, r_{R2}, and r_{R3}, respectively. This geographic data may be stored at server 16, and as described below, may be used carry out the method(s) described herein.

It should be appreciated that the geographic parameter being a radius is merely an example. In other implementations, the geographic data may comprise any geometric shape selected, defined, or predetermined by a user of the communication device 20.

Further, the geographic data may be entered as a single value (e.g., the radius), or it may be entered by other means (e.g., the user may trace or outline a region on a map—e.g., by outlining a geographic region with his/her finger or a stylus). These of course are also merely examples; other implementations exist as well.

In addition, the registering of communication devices 20 in step 205 (FIG. 2) and per method 400 (FIG. 4) may occur at any suitable time. New devices 20 may register while other devices are executing method 200; and previously registered devices may update their registration while method 200 is executed as well. And, as will be appreciated by skilled artisans, step 205 (as well as other communications between devices 20 and server 16) may occur via a packet data connection or PDN (e.g., including cellular data calls), data over a cellular voice call, SMS, voice-over-internet protocol (VOIP), or the like. Following step 205, method 200 proceeds to step 210.

In step 210, a message is received at computer server 16 from one of the communication devices 20—continuing with the example discussed above (in FIG. 6), from source device (S). The message may be any desirable communication by a user (e.g., censored or uncensored, of any suitable length or language, etc.). Continuing with the political example described above, one non-limiting message received by server 16 could be “Meeting up at Boston Harbor to dump some tea. Come join us!” Following step 210, the method proceeds to step 215.

In step 215, the method may determine the group identifier 320 and/or the subgroup identifier 330, 340 associated with the message. In at least one embodiment, this may be included with the message (e.g., in a header file of a PDN); however, this is not required—other means of providing this data are possible. For example, the identifiers 320, 330, and/or 340 could be included in a header or body of an SMS message. Regardless of the means of delivery, continuing with the example above, computer server 16 may determine that the message is associated with the first group identifier 320 (the Libertarian Party group), the first subgroup identifier 330 (the governor of Massachusetts group), and the second subgroup identifier 340 (the taxation issue). Again, these specific identifiers 320, 330, 340 are not intended to be limiting but to merely illustrate one example. After determining this categorical data associated with the message from the source device (S), the method may proceed to step 220.

In step 220, computer server may determine the current location of the source device 20 (S). As used herein, current location includes a precise or approximated location data of the source device (S) and/or the last known location data of the source device. Following registration (step 205), computer server 16 may receive location data (or location identifiers) associated with each of the registered communication devices (which may be received in accordance with each user's privacy permissions). Receiving location data from each static communication device 20a may include mapping an internet protocol (IP) address of the static device; and receiving location data from mobile communication devices (20b) may include receiving GPS data from each mobile device. These are only examples. It should be appreciated that location data may be determined by any suitable means and should be construed broadly to include a mapped IP address, a longitude and latitude value set, a cellular location identifier (e.g., identified using cellular network parameters), a Wi-Fi location identifier (e.g., where the device uses Wi-Fi at a known or determinable location), inertial sensor data associated with the communication device, radio frequency identification (RFID) location data, near-field communication (NFC) location data, Bluetooth beacon data, or terrestrial transmitter data (e.g., Locata™ data), just to name a few non-limiting examples.

Delivery of location data from the communication devices 20 (including source device (S)) may occur repeatedly and may be stored and/or updated at server 16. Thus, step 220 may include receiving new or updated location data or merely determining the last known location of the source device (S). It should be appreciated that while location data may be updated periodically, this is not required; e.g., the timing of location data updates may vary. In at least one embodiment, the location data may be provided in the message sent by the source device (S). In another embodiment, the server 16 may request this location data periodically, request this location data upon receipt of the message from the source device S, or the like. Following step 220, method 200 proceeds to step 225.

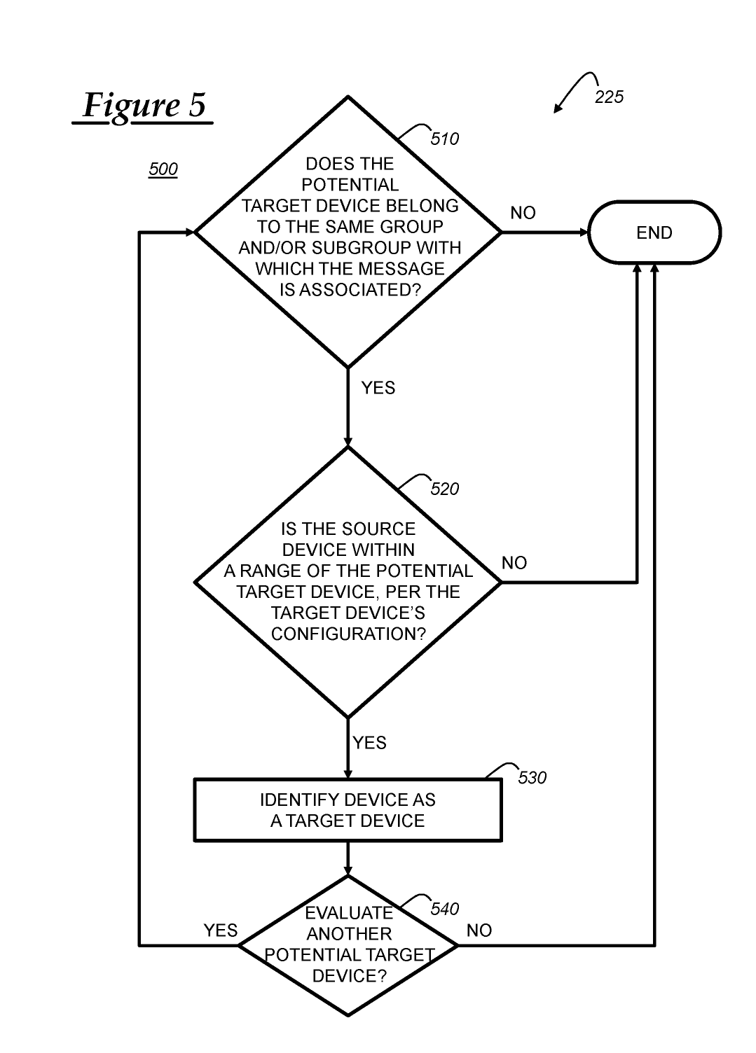

In step 225, computer server 16 may determine the recipient or target devices from among the plurality of communication devices 20. Any communication device 20 (e.g., previously registered with the server 16) which meets a criteria associated with the categorical data (associated with the message) and the geographic data (associated with a geographic proximity of the source device (S)) may be considered a recipient device. Method 500 in FIG. 5 illustrates one embodiment of step 225.

Method 500 begins with step 510 in which the computer server 16 may determine whether the potential recipient device belongs to the same group and/or subgroup that is associated with the message sent from the source device (S). Server 16 may evaluate which registered communication devices 20 belong to the group and/or subgroup by comparing the respective identifiers 320, 330, 340 of the communication devices. In at least one implementation, upon receiving the message, the message may be routed to a dedicated computer server handing all messages associated with a particular group or subgroup (e.g., one of servers 16). Continuing with the political example above—in one implementation, the server 16 may determine which of all communication devices 20 belong to the second subgroup identifier 340 (e.g., associated with taxation); each of these devices 20 may be designated potential recipient devices. Or in another embodiment (of the example above)—the server 16, upon receiving the message, may provide the message to a dedicated server associated with the Democratic Party group which handles all traffic associated with the Libertarian Party group identifier 320. This dedicated server then may determine which of all communication devices 20 already associated with the Libertarian Party group also are associated with the governor of Massachusetts subgroup (e.g., using the first subgroup identifier 330) and the taxation subgroup (e.g., using the second subgroup identifier 340). Each of these devices 20 may be designated potential recipient devices. In method 500, those communication devices 20 which do not belong to the group or subgroup associated with the message are no longer considered (and with respect to those devices, the method ends). In instances where recipient devices exist that are associated with the same identifiers 320, 330, 340, the method continues from step 510 to step 520.

In step 520, computer server 16 then determines whether the source device (S) is within a desired range of the potential recipient devices, according to the respective user's configuration of geographic data associated with the potential recipient device. FIG. 6 illustrates an example. In FIG. 6, two communication devices 20 (R2, R3) are within range and one (R1) is not. Recalling that in the continuing example, devices R1, R2, and R3 were all potential recipient devices (e.g., all belonging to the specific group and subgroups associated with the message sent by the source device (S))—here, computer server 16 determines whether the source device (S) is within the range set by one of the potential recipient devices (e.g., device R2). Server 16 determines that device R2 is within range (i.e., within radius r_{R2}) of source device (S). Similarly, server 16 determines that device R3 is within range (i.e., within radius r_{R3}) of source device (S), but that device R1 is not.

It should be appreciated that determining whether the source device (S) is within the desired range of the potential recipient devices may be time-sensitive (or time-responsive). For example, making this determination may include the source device (S) being within the geographic region within a predetermined period of time of a user of the source device composing the message, the source device sending the message, or the server receiving the message, just to name a few example. Following step 520, method 500 then proceeds to step 530.

In step 530, the potential recipient device R2 is determined or identified to be an actual recipient device 20 for the particular message in response to the determination in steps 510 and 520. The method then proceeds to step 540.

In step 540, computer server 16 may evaluate another potential recipient device.

For example, potential recipient device R3 may proceed from step 510 to 520 (since the user of R3 belongs to the particular taxation subgroup), and in step 520, server 16 may determine that source device (S) is within the range set by potential recipient device R3 (i.e., within radius r_{R3}). Thus, device R3 may be identified as another actual recipient device in step 530. Of course, evaluation of any and/or all potential recipient devices (e.g., R2, R3, etc.) could occur concurrently or nearly so.

However, while potential recipient device R1 may proceed similarly from step 510 to 520 (belonging to the taxation subgroup), device R1 may not be identified as an actual recipient device because server 16 will determine in step 520 that source device (S) is not within the range set by the user of the potential recipient device R1 (i.e., within radius r_{R1}). Thus, for device R1, the method ends. This step may be repeated for additional devices. In addition, it is contemplated that computer server 16 could be configured to determine ranges of the communication devices concurrently (e.g., not necessarily sequentially).

Once all registered communication devices have been evaluated, the method 500 ends and step 225 of method 200 is complete. Thereafter (as shown in FIG. 2), method 200 proceeds to step 230. It should be appreciated that evaluation of all communication devices 20 broadly includes instances where each device is individually evaluated according to method 500 or devices 20 are evaluated at different (e.g., dedicated) servers that may be used for one or more particular categorical identifiers 310. Also, evaluating all communication devices may include omitting some communication devices for various reasons (e.g., users have revoked location privileges, communication devices which have not updated location data for a predetermined period of time, users which have deleted account data associated with their initial registration, and the like). Further, it should be appreciated that potential recipient devices R1, R2, and R3 were merely examples to illustrate how method 500 (and method 200) operate. More or less potential recipient devices may exist; further, in some instances, no potential recipient devices may be within the range of source device (S).

In step 230 of method 200 (FIG. 2), the computer server 16 transmits the message to the actual or determined recipient devices at least partially in response to the determination made in step 225. Whether the message is received via the land network system 12, the wireless communication infrastructure 14, or a combination thereof, ultimately it is received by respective users of the recipient devices (e.g., R2 and R3). In at least one embodiment, the sender may be unaware of the identity of the recipients. Thereafter, the method ends.

Other embodiments also exist. For example, in at least one embodiment, computer server 16 provides a message to the sender following step 230. The message to the source device (S) may include a quantity or number of recipient devices to which the message was transmitted.

In another embodiment, the registration data of step 205 (FIG. 2) includes account data (e.g., one or more of the following: a first and last name of a user of the communication device 20, an associated e-mail, an associated phone number, a username, a password account challenges, etc.). And in one embodiment, at least a portion of the account data (e.g., the username) of each of the recipient devices in step 230 (e.g., R2, R3) is provided to the source device (S), providing the users agree (or previously agreed) to do so.

In another embodiment, a recipient communication device 20 may define different geographic data for different categorical data. Thus, for example, categorical data pertaining to political subject matter may be received from source devices within the same state or within a common state boundary, categorical data pertaining to music live performance subject matter may be received from source devices within a common metropolitan city or area, and categorical data pertaining to a neighborhood crime watch subject matter may be received from source devices within a common surrounding neighborhood. These of course are merely examples to illustrate one exemplary embodiment and are not intended to be limiting. Other like examples also exist.

In another embodiment, the messaging system operates to provide messages to other communication devices 20 in response to the proximity of the recipient device(s) without evaluating or otherwise considering the categorical data. For example, the messaging system may be operative solely based on geographic parameters of the registered communication devices 20.

In another embodiment, the communication between computer server 16 and communication devices 20 occurs via other types of wired and wireless communication. Non-limiting examples include any suitable mesh network, any suitable short range wireless communication (SRWC) link (including but not limited to 802.11 standards, Wi-Fi Direct, Bluetooth, WiMax, etc.), satellite communication (e.g., satellite uplinks and/or downlinks), Light Fidelity (a.k.a., Li-Fi) technology, and the like. The server 16 may communicate with communication devices 20 using one or more of these techniques and/or the land network system 12 and/or wireless communication infrastructure 14 and vice-versa, communication devices 20 may communicate with computer server 16 using one or more of these techniques and/or the land network system 12 and/or wireless communication infrastructure 14.

Thus, there has been described a messaging system for providing messages to users of communication devices. A computer server may determine potential recipient or target devices of the message based on their proximity to a source or sender of the message (e.g., a user of another communication device). More specifically, the target devices may provide a predefined geographic area or region that includes the respective target device—so that when a source device is located within the predefined geographic area and sends a message, the target device receives it. And when the source device is outside of the predefined area and sends the message, the target device does not receive it.

In addition, the messaging system may provide the message to a subset of target recipients (i.e., recipients each within a respective target region defined by the respective target device). The subset of target recipients may be determined using common categories (e.g., groups or subgroups) to which both the source and potential target devices subscribe or belong. Therefore, in some instances, potential target devices are determined by proximity as well as a category. For example, the message is delivered to the target device when source device is located within a geographic area predefined by the respective target device and the source and target devices belong to the same group and/or subgroup(s).

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method of providing messages between communication devices using a computer server, comprising the steps of:
receiving at the computer server registration data from a plurality of communication devices, wherein each registration data includes predefined geographic data that includes the respective communication device;
receiving at the computer server location data from a source device, wherein the source device is the one of the plurality of communication devices;
receiving a message from the source device;
determining a target device from among the plurality of communication devices, wherein the target device is determined when the location data of the source device is within a region associated with the predefined geographic data of the target device; and
in response to the determination, transmitting the message to the target device.

2. The method of claim 1, further comprising transmitting the message to a plurality of target devices from among the plurality of communication devices, wherein the location data of the source device is within a region associated with predefined geographic data associated with each of the plurality of target devices.

3. The method of claim 1, wherein the geographic data includes is a radius at least partially surrounding from the target device.

4. The method of claim 1, wherein the registration data further comprises at least one categorical identifier, wherein the geographic data is associated with the at least one categorical identifier.

5. The method of claim 1, wherein the determining step further comprises:
determining a categorical identifier of a potential target device;
determining a categorical identifier associated with the source device; and
determining that the potential target device is the target device when the categorical identifier of the potential target device is the same as the categorical identifier associated with the source device and when the source device is within the region associated with the predefined geographic data of the target device.

6. The method of claim 5, wherein the source device is within the region within a predetermined period of time of a user of the source device composing the message, the source device sending the message, or the server receiving the message.

7. The method of claim 1, wherein the registration data further comprises at least one categorical identifier, wherein the at least one categorical identifier includes one or more group identifiers, one or more subgroup identifiers, or a combination thereof.

8. The computer server, comprising:
one or more processors; and
a non-transitory computer readable medium having data stored therein representing software executable by the one or more processors, the software having instructions configured to perform the method steps of claim 1.

9. A non-transitory computer readable medium having data stored therein representing application software executable by a mobile device, the software having instructions, the instructions including:
storing registration data received from a user of the mobile device;
determining location data of the mobile device;
providing the registration data and the location data to a computer server in communication with a plurality of communication devices;
receiving user input representing a first message intended for delivery to a target device, wherein the target device is one of the plurality of communication devices; and
transmitting the first message to the computer server for intended delivery to the target device, wherein the first message is received by the target device when the location data of the mobile device is within a geographic region predefined by a user of the target device.

10. The non-transitory computer readable medium of claim 9, wherein the registration data further includes a categorical identifier determined by the mobile device user, wherein the received user input includes associating the first message with the categorical identifier, wherein the first message is received by the target device when the location data of the mobile device is within a geographic region predefined by the user of the target device and when a categorical identifier determined by the user of the target device corresponds to the categorical identifier determined by the mobile device user.

11. The non-transitory computer readable medium of claim 9, wherein the registration data of the mobile device comprises a categorical identifier defined by the user of the mobile device and a geographic parameter defined by the user of the mobile device.

12. The non-transitory computer readable medium of claim 11, the instructions further comprising:
receiving a second message from a source device via the computer server, wherein the source device is one of the plurality of communication devices, wherein the second message is associated with a categorical identifier determined by a user of the source device that is the same as the categorical identifier defined by the user of the mobile device.

13. The non-transitory computer readable medium of claim 12, wherein a location of the source device is within a geographic region defined by the geographic parameter stored within the mobile device.
